(19) United States
(12) Patent Application Publication
(10) Pub. No.: US 2020/0178546 A1
(43) Pub. Date: Jun. 11, 2020

(54) Smoke-Producing Device for an Outdoor Grill

(71) Applicant: Martin Forrester, Palmdale, CA (US)

(72) Inventor: Martin Forrester, Palmdale, CA (US)

(21) Appl. No.: 16/708,610

(22) Filed: Dec. 10, 2019

Related U.S. Application Data
(60) Provisional application No. 62/778,104, filed on Dec. 11, 2018.

(51) Int. Cl. A23B 4/052; A47J 37/07; B21D 5/00

(52) U.S. Cl. CPC A23B 4/052; B21D 5/00; A47J 37/0786

(57) ABSTRACT

A re-useable smoke-producing device for use in burning pre-soaked wood chips on an outdoor propane or charcoal grill, with the device being made of a stainless steel cylinder with holes punched in a pattern on the body of the cylinder and the base of the cylinder, with the holes of a size and pattern that allow for optimal smoke production. The device stands upright on a grill surface, is open on the top end, and allows for the grill cover to be closed over the device. The device has a handle for safe and convenient removal of the device from the grill.

### CROSS REFERENCE TO RELATED APPLICATION

This application claims the benefit of U.S. Application Ser. No. 62/778,104, entitled “Smoke-Producing Device for an Outdoor Grill,” filed Dec. 11, 2018, the entire disclosure of which is incorporated herein by reference.

### FIELD OF THE INVENTION

The present disclosure relates to devices used for generating smoke to flavor food on an outdoor grill.

### BACKGROUND OF THE INVENTION

Smoking meats has evolved into an art form in many areas of the United States, with the use of portable smoking devices in backyards, tailgates, and even regional and national competitions. A challenge in the area has been to develop a smoker device that produces an optimal amount of smoke to flavor food, that is easily portable., that is efficient for the user, and that provides for safe handling.

Using wood chips and wood chunks to smoke meat is often time-consuming and labor-intensive for the cook.

Large smoker devices, such as offset smokers, are cumbersome (sometimes weighing hundreds of pounds) for transporting from one location to another and take up a lot of space in a yard or on a deck. Offset smokers traditionally have a drum barrel body, a chimney and a side-mounted firebox. Other large smoker devices include water smokers, box, barrel and pellet smokers. Large smoker devices can also be very expensive, with well-constructed offset smokers costing $1000 and up. Another disadvantage of large smoker devices is the vulnerability of their performance to windy, rainy or cold weather conditions.

Traditional gas or propane grills do not provide food with the desired smoke flavor that can be obtained from a dedicated wood burning smoker.

Various devices and methods have been developed and tried by cooks over the years to add smoke flavor to food cooked on outdoor grills. For example, the Smokenator® Prism (“Prism”), https://www.smokenator.com/, is a stainless steel smoker box that holds hardwood pellets for smoking food on a gas or charcoal grill. The Prism lays flat on a surface and has caps on each end. A disadvantage of the Prism is that a cook must pick up the Prism without spilling the contents and without getting injured by coming in contact with a hot surface. Further, the entire surface of the Prism is covered in holes, potentially resulting in too much smoke being produced.

In addition, smoke boxes have been used which are generally made of a box or container that holds water-soaked wood chips and has a lid with holes to allow smoke to dissipate. Pouches made of hole-punched aluminum foil have also been used. See U.S. Pat. No. 4,779,525, Smoke Generating Device (stating that “In the preferred embodiment, device 10 is cylindrical in form, being rolled from aluminum foil and having its ends closed”).

Smoke boxes or other containers used in the past have been placed on a grill near or in contract with a burner flame. These devices allow smoke creation as the wood chips are heated and the water in the wet wood chips vaporizes. However, this generally does not create the desired smoke taste in meat or other food. Also, after the wood chips in a conventional smoke box or container begin to char, this will provide some smoke flavor but not the desired smoke accents and smoke rings that result from a dedicated wood burning smoker.

Other devices used with outdoor grills have included moving parts, such as a regulator that must be adjusted by the user. See U.S. Pat. No. 9,603,372 B2, Wood Chip Smoker for Outdoor Grills. Some devices have included a cover on one end that must be manipulated and removed by the cook to add wood chips during the cooking process and results in additional clean-up. See U.S. Pat. No. 10,021,889, Grill Smoker Apparatus. Some devices only allow for smoke to emit from one end of a device. See U.S. Patent Application 2014/0216274, Smoke Producing Device and Method for Outdoor Cookers. Further, some devices have a cover with a port for emitting smoke in a particular direction. See U.S. Pat. No. 9,486,000, Grilltop Smoker Box (FIG. 1).

It would be advantageous to develop a device that provides optimal smoke permeation in an outdoor grill where the device is also easily handled and allows for 360° of smoke emission.

### SUMMARY OF THE INVENTION

The invention disclosed herein relates to a smoker device that provides optimal smoke production for smoking meats or other food on an outdoor propane or charcoal grill with minimal adjustment by a cook. The invention is designed to allow a cook to easily add smoke flavor to meats or other foods while cooking on an outdoor grill.

The device is a stainless steel cylinder with perforated holes in a columned pattern around the cylinder, as, well as perforated holes in the base of the device. The cylinder has a handle, stands about seven inches in height, 4 and ¾ inches in width, and has a weight of about one pound.

### BRIEF DESCRIPTION OF THE DRAWINGS

FIG. 1 shows a side view of the smoker device.

FIG. 2 shows a bottom view of the smoker device.

FIG. 3 shows a different side view of the smoker device.

Terms used in this application are defined below.

Wood chips: Wood chips refer to either wood chips or wood chunks that may be of different wood varieties, such as hickory, pecan, apple, mesquite or oak wood. Wood chips are also sometimes made from barrels or other wood items, such as Jack Daniels® barrels. Wood chips are commonly found for purchase at retail stores or sporting outlets.

All other terms used in this specification are given their usual and customary definitions as used by one of ordinary skill in the field.

### DETAILED DESCRIPTION OF AN EXEMPLARY EMBODIMENT

The present disclosure describes and claims a device for smoking foods on an outdoor propane or charcoal grill. The present invention reduces the risk of injury when the cook periodically adds pre-soaked wood chips or wood chunks, as the cook simply drops the wood chips or wood chunks into the open top of the device. Thus, the invention allows for safer handling and cleaning and provides 360° of smoke emission on an outdoor grill.

The device allows for a maximum amount of air flow and allows the device to produce smoke comparable to that produced by a large smoker, such as those described above.

The device is designed to allow for easy clean-up and transport. The device may be rinsed out with water after use. Because of the compact size, and weight of only about a pound, the device is more easily transported than a traditional large smoker while providing similar quantity and quality of smoke flavor and markings to food.

Thus, in one aspect, the invention is a hollow stainless-steel cylinder, open at the top end and closed at the bottom end, forming a base. The height of the device is tall enough and wide enough to allow a chef to put sufficient charcoal and wood chips but not so tall as to interfere with closing the grill cover. Generally, a cook will need to add approximately a hand-full of wood chips or wood chunks about every 30 to 45 minutes, depending on the amount of water absorbed by the chips during the pre-soaking process. In a preferred embodiment, the device is about seven inches in height and about 4¾ inches in diameter, with a weight of about one pound. The body of the cylinder and the base have holes in the stainless steel. The holes in the body of the cylinder are arranged in about six sets of three columns each, and alternate in size by row within the columns. Most of the holes in the body of the cylinder are approximately 0.3 inches in diameter, except that some holes have a diameter of approximately 0.4 inches. The holes in the base of the cylinder also vary in size from approximately 0.3 inches to 0.4 inches in diameter. The holes in the body and base of the cylinder are spaced about 0.3 inches apart.

The stainless steel in the body and base of the cylinder is approximately 0.050 inches, or 1/16 inch, in thickness.

A handle of made stainless steel is attached at two ends to the outside body of the, cylinder and extends out from the cylinder by a distance sufficient to allow an oven mitt or other heat, protective device such as a pot holder, to pass through between the body and handle. In one embodiment, the handle extends out of about one inch and the length of the handle, is about 5.4 inches.

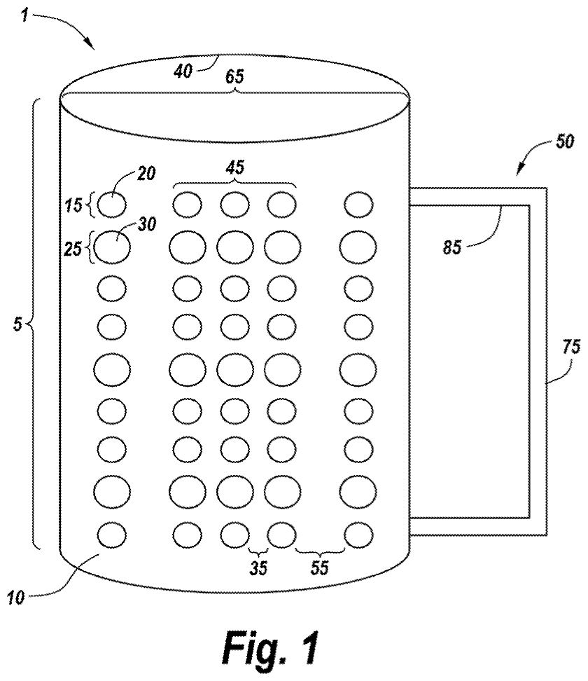

FIG. 1 is a diagram of one aspect of the invention. This aspect of the device 1 shows the body 5 of the cylinder 10 with holes 20 of approximately 0.3 inches in diameter 15 as well as larger holes 30 of approximately 0.4 inches in diameter 25. The holes are spaced approximately 0.3 inches apart 35. The holes are arranged in sets of columns 45 around the cylinder 10, with the columns spaced approximately inch apart 55. The open top 40 of the cylinder is shown with a diameter of approximately 4.6 inches 65. A handle 50 with a length of approximately 5.4 inches 75 is shown extending a distance of approximately one inch 85 from the exterior of the cylinder 10.

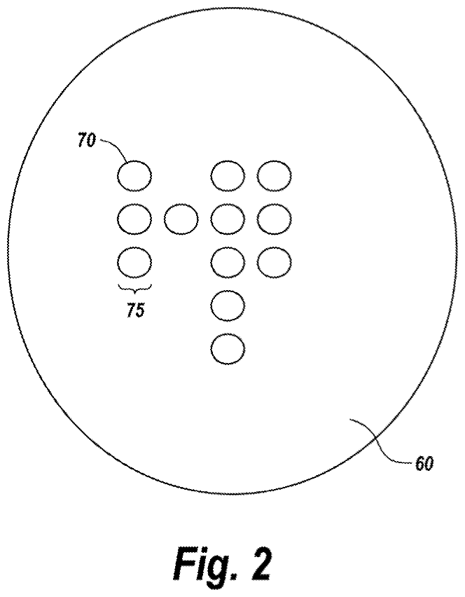

FIG. 2 is a view of the base 60 of the cylinder 10. The holes 70 in the base have a diameter of approximately 0.4 inches 75.

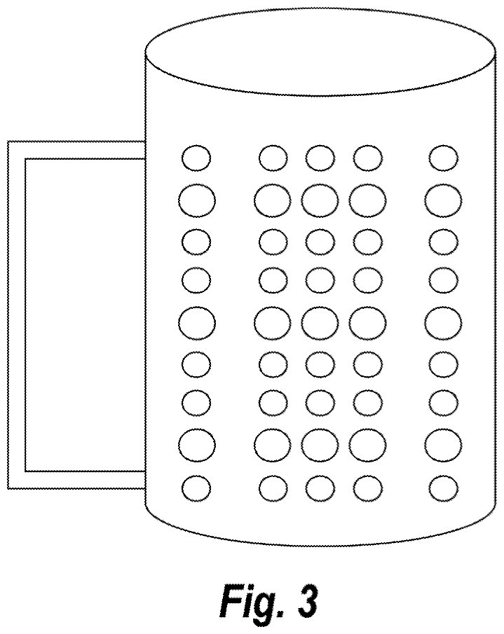

FIG. 3 shows the device of FIG. 1 turned 180°.

The device can be made from flat stock metal, preferably stainless steel, and formed into a substantially cylindrical shape. The hole pattern can be punched, stamped or lasered into the metal sheet, before or after it is formed into a cylinder, and then polished for burn and rough surfaces. The side and bottom piece can be welded onto the cylinder. Alternative methods of forming sheet stock into forms are well known in the art. While a cylindrical shape is the preferred design, other shapes may be employed. The device may be of varying heights to allow for use in grills of different sizes and with different clearance heights between the grill surface and a closed grill cover.

To use the device, a cook would place the device on a grill surface above an open name, for example, on the food grates. A cook then adds about a dozen pre-lit charcoal briquettes to the inside of the device followed by pre-soaked wood chips until the device is about ¾ half. Ideally, the wood chips should he soaked for two hours prior to use. I f using wood chunks, the chunks should be soaked for at least eight hours prior to use, and the chunks should fill the device to the top. After adding the wood chips or wood chunks, the lid of the grill should be closed.

The spacing and arrangement of the holes on the device provides for optimal smoke production. The holes permit the smoke to emit from the open top of the device as well as the sides, providing smoke in any direction and allowing cooks to add smoke flavor to foods regardless of where the foods are placed on the grill surface. The holes on the bottom allow for oxygen to feed the burning in the device.

As the wood begins to burn in the smoker, the grill will be filled with a continuous supply of smoke. Periodically, more wood chips or wood chunks can be added to the device. The cook can add more wood chips or wood chunks to the device by simply opening the cover of the grill and adding the wood chips or wood chunks directly into the device without having to remove the device from the grill. The burning wood creates coals as it slowly burns, which creates its own heat source to ignite wood added to the device.

Because the smoker rests inside the grill, the smoker never makes contact with the food being smoked. Food for patrons with different dietary restrictions can be smoked in the same grill. The size of the smoker makes it convenient for back yard grills, travel, and the like, and does not take up much space reserved for food on the grill. The smoker also eliminates the need for a separate smoker device.

While the foregoing written description of the invention enables one of ordinary skill to make and use what is considered presently to be the best mode thereof; those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

All references, patents, and patent publications described herein are incorporated by reference in total.

I claim:

1. A barbeque smoking device, comprising:
a substantially cylindrical shaped hollow body having an open top end and a closed bottom end;
a handle affixed to body at least one attachment point near the top end;
a plurality of first and second holes arranged along the body;
a plurality of third holes and fourth holes arranged in the closed bottom end.

2. The device of claim 1 wherein the first holes and second holes differ from each other in diameter of approximately of 0.1 inch and the third holes and fourth holes differ from each other in diameter of approximately 0.1 inch.

3. The device of claim 1 wherein the plurality of first and second holes are arranged in a pattern of columns spaced approximately 1.0 inches apart around the circumference of the body;
with each column comprising of at least nine rows of three first or second holes per row spaced approximately 0.3 inches apart; and
with the rows of holes alternating between first holes and second holes in the column;

4. The device of claim 3 wherein the rows alternate with first holes of approximately 0.3 inches with second holes of approximately 0.4 inches in diameter.

5. The device of claim 2 wherein the plurality of third and fourth holes in the base are arranged in an asymmetrical pattern.

6. The device of claim 1 where the device is stainless steel with a thickness of approximately 0.05 inches.

7. The device of claim 1 where the handle forms a second attachment point to the body a point above the base and encloses an aperture of size that allows an oven mitt to pass through the aperture.

8. The device of claim 1 wherein the body has a height that permits the cover of a barbeque grill to be closed when the device is placed inside the barbeque grill and a diameter that allows for food items to be placed on the barbecue grill at the same time as the device.

9. A method of manufacturing a barbeque smoker comprising the steps of:
providing a first sheet of metal having a plurality of holes therein and a second sheet of metal having a plurality of holes;
forming the first sheet of metal into a hollow cylindrical body having a first end and a second end; and
attaching a handle by welding or other fixed means to the outside body.

10. The method of claim 9, wherein the step of forming the first sheet of metal into the body comprises to steps of:
rolling the first sheet of metal into the body;
welding a generally circular piece of metal onto the second end to close the end, the piece of metal having at least the same diameter of the body, and trimming any protruding excess metal from the body.
